(19) United States
(12) Patent Application Publication
(10) Pub. No.: US 2006/0117034 A1
(43) Pub. Date: Jun. 1, 2006

(54) Migrating spatial data between databases

(75) Inventors: Serguei Sokolov, Ottawa (CA); Geoffrey D. Zeiss, Ottawa (CA)

Correspondence Address: GATES & COOPER LLP;HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/000,674

(22) Filed: Dec. 1, 2004

(51) Int. Cl. G06F 7/00

(52) U.S. Cl. 707/100; 707/1

(57) ABSTRACT

A method, apparatus, and article of manufacture for migrating facilities spatial data between databases that maintains the positional accuracy of the facilities spatial data in a target database. A first network topology associated with a first landbase map and a second network topology associated with a second landbase map are built using landbase objects and accessed to automatically map identical nodes and segments therebetween, thus creating a correspondence matrix. Spatial relationships between at least one facilities object and landbase objects associated with the first network topology are identified and recorded. Using the correspondence matrix and the explicitly recorded relationships, the second landbase map is automatically populated with the facilities object according to the identified spatial relationships applied against the second network topology. The positional accuracy of the facilities spatial data in relation to the second landbase map is maintained.

### BACKGROUND OF THE INVENTION

1. Field of the Invention

The present invention relates to migrating data, and more particularly to migrating spatial facilities data between geographic databases maintaining the positional accuracy of the migrated facilities data.

2. Background of the Related Art

Migration of spatial facilities data is a problem faced by all organizations that maintain a spatially distributed facilities network including telecommunications organizations, utility companies (electric, gas, water, waste water, and storm water), pipeline companies, and government agencies responsible for maintaining databases of facilities data. These organizations maintain facilities maps that are based on a geographic database of buildings, roads, boundaries, and rivers, called “landbase” maps, upon which the location of their facilities are recorded.

The landbase maps, upon which organizations record the location of their facilities, are continually evolving. Accordingly, these organizations face a common problem in which their facilities data become incorrectly positioned as the landbase maps change. The specific problem these organizations face is the need to migrate data from an older landbase map to a more recent landbase map without the loss of the positional accuracy of their facilities. Migration difficulties arise because the facilities information is spatially registered against specific landbase features, but the spatial relationships between facilities and landbase features is implicit and is not maintained during migration using older migration techniques.

Historically, the techniques for migrating facilities data from older landbase maps to newer landbase maps that have been utilized are redrafting and conflation. Redrafting, which is frequently used, is completely manual and requires manually redigitizing the location of facilities on the new landbase map to create a new facilities map. The advantage of redrafting is that the positional quality of the new facilities maps on the new landbase is comparable to the quality of the original facilities maps on the old landbase. However, redrafting facilities data can be expensive and time consuming.

Conflation refers to the integration of data from different sources based on a geometric transformation. It has been applied to the transfer of spatial data from older landbase maps to new landbase maps, as discussed herein. For the purposes of migrating facilities data from an old landbase map to a more recent landbase map, conflation combines stretching, rotation, translation, and sometimes nonlinear warping often referred to as “rubber-sheeting” based on a set of control points (data points whose exact location is known in the old and the new landbases) in an attempt to fit the facilities data to the more recent landbase map. The advantage of this approach is that it is less expensive and more rapid than redrafting. Unfortunately, conflation may fail to maintain the spatial relationship between the facilities data and specific features in the landbase, and consequently facilities maps may be positionally of lower (in many cases, unacceptable) quality than the original facilities maps. For example, a cable may appear on an opposite, i.e., “wrong,” side of the road on the new landbase, if compared with the location of the same cable on the old landbase.

Accordingly, what is needed is a method for migrating spatial facilities data between geographic databases while maintaining the positional accuracy of the migrated facilities data.

### SUMMARY OF THE INVENTION

The present invention describes a method, apparatus, and article of manufacture for migrating facilities spatial data between databases that maintains the positional accuracy of the facilities spatial data in a target database. A first network topology associated with a first landbase map and a second network topology associated with a second landbase map are built using landbase objects and accessed to automatically map identical nodes and segments therebetween, thus creating a correspondence matrix. Spatial relationships between at least one facilities object and landbase objects associated with the first network topology are identified and recorded. Using the correspondence matrix and the explicitly recorded relationships, the second landbase map is automatically populated with the facilities object according to the identified spatial relationships applied against the second network topology. The positional accuracy of the facilities spatial data in relation to the second landbase map is maintained.

### BRIEF DESCRIPTION OF THE DRAWINGS

Referring now to the drawings in which like reference numbers represent corresponding parts throughout:

FIG. 1 illustrates a network architecture, in accordance with one embodiment;

FIG. 2 shows a representative hardware environment that may be associated with the data server computers and/or end user computers of FIG. 1, in accordance with one embodiment;

FIG. 3 illustrates a schematic diagram for migrating spatial data between databases in accordance with one embodiment;

FIG. 4 illustrates a schematic diagram showing features of the first network topology and the second network topology, in accordance with one embodiment;

FIG. 5 illustrates a flowchart showing the process for matching the first network topology and the second network topology, in accordance with one embodiment;

FIG. 6 illustrates a schematic diagram of a road segment centerline from the first network topology and a road segment centerline from the second network topology in accordance with one embodiment;

FIG. 7 illustrates a flowchart showing the workflow for recording relationships between landbase features and facilities objects, in accordance with one embodiment;

FIG. 8 illustrates a flowchart illustrating a process for addressing unprocessed vertices and/or points, in accordance with one embodiment;

FIG. 9 illustrates a flowchart for illustrating the migration of the one or more facilities objects in accordance with one embodiment; and

FIG. 10 illustrates a schematic diagram illustrating the resultant migration of facilities data from the old landbase to the new landbase in accordance with one embodiment.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

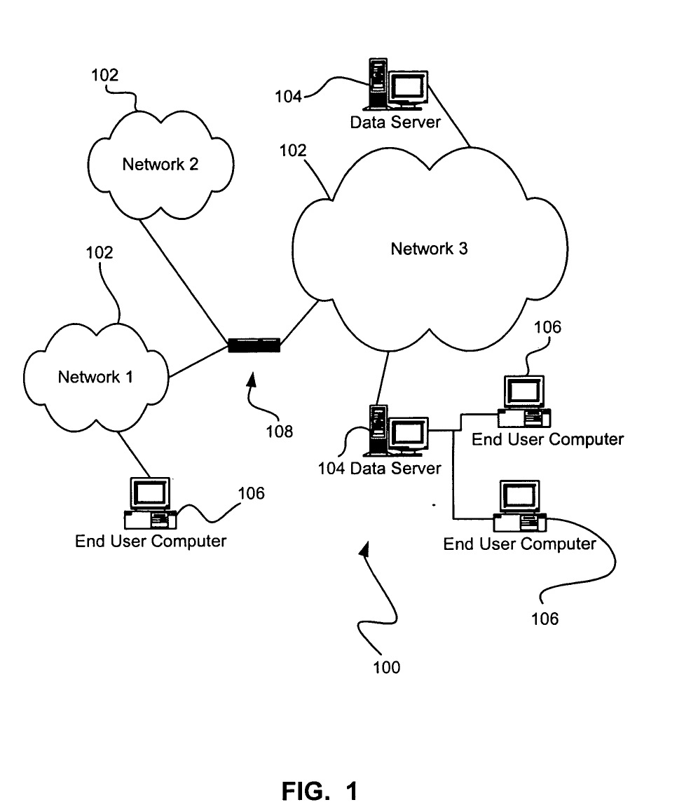

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wide area network (WAN) such as the Internet, etc.

Coupled to the networks 102 are data server computers 104 which are capable of communicating over the networks 102. Also coupled to the networks 102 and the data server computers 104 are a plurality of end user computers 106. In order to facilitate communication among the networks 102, at least one gateway or router 108 is optionally coupled therebetween. It should be noted that each of the foregoing network devices as well as any other unillustrated devices may be interconnected by way of a plurality of network segments.

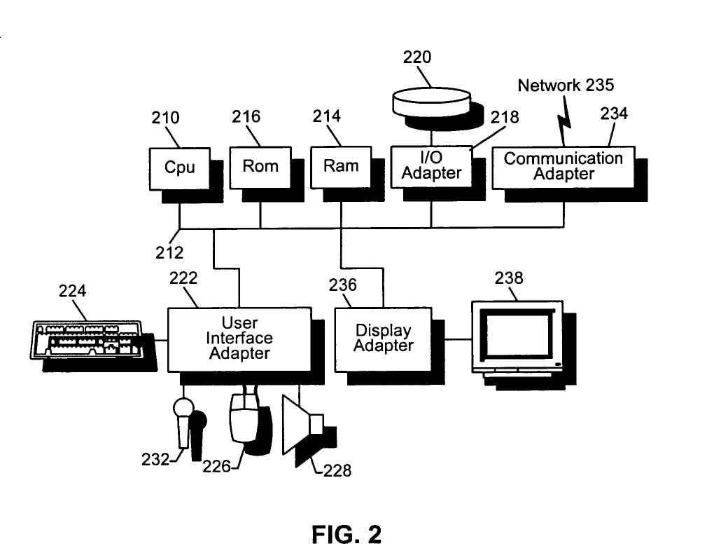

FIG. 2 shows a representative hardware environment that may be associated with the data server computers 104 and/or end user computers 106 of FIG. 1, in accordance with one embodiment. Such figure illustrates a typical hardware configuration of a workstation in accordance with a preferred embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that a preferred embodiment may also be implemented on platforms and operating systems other than those mentioned. A preferred embodiment may be written using JAVA, C, and/or C++ language, or other programming languages, along with an object oriented programming methodology.

Of course, the various embodiments set forth herein may be implemented as a method, apparatus or article of manufacture, utilizing hardware, software, or any desired combination thereof. For that matter, any type of logic may be utilized which is capable of implementing the various functionality set forth herein.

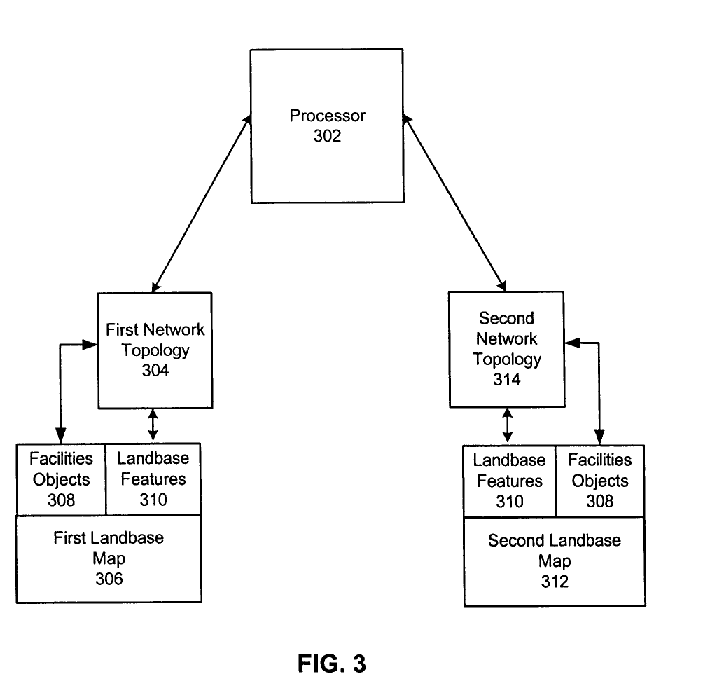

Turning now to FIG. 3, a schematic diagram for migrating spatial data between databases is shown. A processor 302 accesses a first network topology 304 associated with a first landbase map 306. A network topology, such as the first network topology 304 discussed herein, may be a combination of road intersections (Nodes) linked by road centerlines (Segments). Nodes and segments are further discussed herein. A network topology may be created for old landbase maps and new landbase maps based on geographic network of roads, railways, rivers and other real-world landbase objects. A network topology may thus provide a basis for automation of mapping identical network nodes and segments in old and new landbase maps. In this embodiment, the first landbase map 306 and/or the second landbase map 312 may be old landbase maps or new landbase maps. The first landbase map 306 and/or the second landbase map 312 may be based on non-georeferenced (e.g. schematic diagrams, unprotected) spatial data and/or georeferenced (e.g. geodetic measurements, geographic or projected coordinates) spatial data.

Spatial relationships between at least one facilities object 308 associated with the first network topology 304 and landbase features 310 associated with the first network topology 304 are then identified by the processor 302. A spatial relationship may be, for instance, the distance measured along the road (a segment in the topology network) that a telephone pole is located from a road intersection (a node in the topology network) and the offset of the telephone pole from a road segment that makes up part of that road intersection. This method for defining spatial relationships may also be known as a “linear referencing”. However, any parameters for defining spatial relationships between the facilities object 308 and the landbase features 310 are within the scope of this embodiment. Further, any parameters for defining the spatial relationships between any objects, features, etc. are within the scope of this embodiment.

Landbase features, such as the landbase features 310 associated with the first network topology 304 discussed herein, may be road centerlines, railroads, rivers, etc. Facilities objects, such as the facilities object 308 discussed herein, may be cables, poles, transformers, water/sewer pipes, etc. Any type of landbase features 310 and facilities objects 308 are within the scope of this embodiment.

A second landbase map 312 is automatically populated with the facilities object 308 according to the spatial relationships. Population, or migration, of the second landbase map 312 with the facilities object 308 indicates that the positional accuracy of the migrated facilities data may be maintained. The second landbase map 312 has associated with it a second network topology 314. The first network topology 304 and/or the second network topology 314 may be defined as a combination of road centerlines and road intersections represented on a landbase map. The road centerlines lines and road intersections may be embodied on a paper map, a digital map, etc. Any network topology that can be formed using objects from a landbase map is within the scope of this embodiment. Either the first network topology 304 and/or the second network topology 312 may be based on road centerlines and road intersections. However, any landbase feature, such as rivers, may be utilized for providing the foundation for the first network topology 304 and/or the second network topology 314. Although the first network topology 304 and/or the second network topology 314 are described as being accessed by the processor 302 in this embodiment, the first network topology 304 and/or the second network topology 314 may be built using any geographic information system tool, computer aided drawing tool, such as AUTODESK MAP, etc.

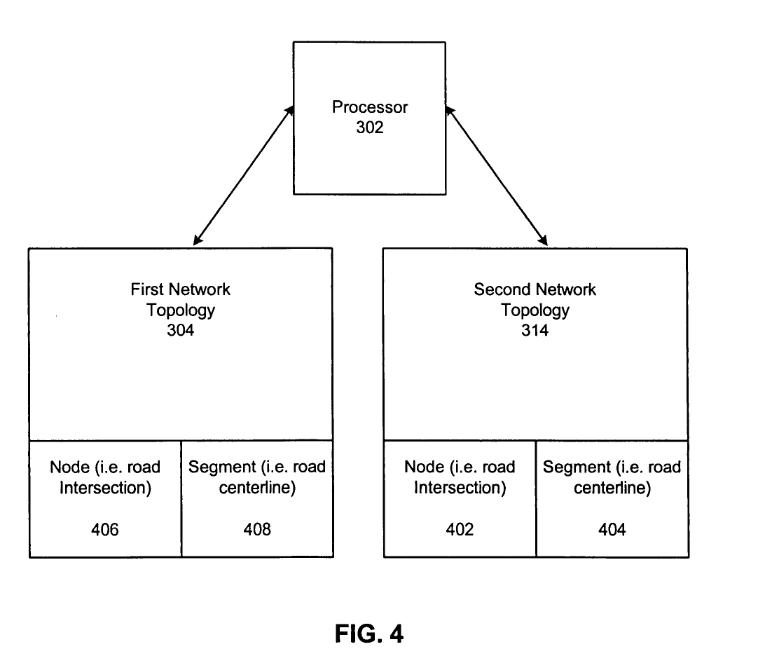

Turning now to FIG. 4, a schematic diagram illustrating features of the first network topology 304 and the second network topology 314 are shown. In order to initiate the automated population of the second landbase map 312 with the facilities object 308, a user selects an intersection 402 from the second network topology 314 associated with the second landbase map 312 and an identical intersection 406 associated with the first network topology 304. The intersections 402, 406 selected by the user may be referred to as a “start node” since it typically initiates the automated process of creating the correspondence matrix. The intersections 402 selected from the second network topology 314 correspond to the identical intersection 406 associated with the first network topology 304.

Any intersections, such as the intersection 406 associated with the first network topology and/or the intersection 402 associated with the second network topology, may be known as a “node.” A node may represent the location where three or more “segments” cross or intersect. “Segment” may be defined as an object composed of one or more connected geometries treated as a single object. For instance, all road centerlines between two intersections may constitute a segment in the network topology. Segments that exit from a particular intersection may be known as “exits.” For purposes of a landbase map, segments are typically roads (road centerlines), while nodes are typically road intersections. However, any representation of segments and/or nodes is within the scope of this embodiment.

Once the node 406 is selected by the user, the second network topology 314 is traversed to locate the nodes 402, as well as the segments 404, that are identical to the nodes 406 and the segments 408 associated with the first network topology 304. The process of traversing the second network topology 314 to identify nodes 402 and segments 404 that are identical to the nodes 406 and segments 408 associated with the first network topology 304 may be automated, partially automated, and/or manual. In one embodiment, for the nodes 402 associated with the second network topology 314, all segments 404 connected to the node 402 are validated according to a comparison of the node 406 and the segments 408 located on the first network topology 304. The comparison may be based on the number of segments connected to the node, length of segments, shape and direction of segments and any tabular information, such as road/street names, number of lanes, etc., associated with the landbase map objects that were used to create the network topology. If the node 402 passes the comparison criteria, the node 402 is mapped as identical to the node 406 and traversing continues to the next node 406 in the network the first network topology 304.

The spatial relationships between the facilities object 308, nodes 402 and segments 404 associated with the first network topology 304 are identified and recorded. The facilities object 308 is then located in relation to the nodes 402 and segments 404 according to the recorded spatial relationships. The process of locating the facilities object 308 on the second network topology 314 may be automatic, partially automatic, and/or manual.

The facilities object 308 may be populated according to a specified order. The specified order may provide that the sequence of the second landbase map 312 population is according to the facilities object 308 that represent manholes, poles, interface terminals, distribution terminals, and cables. For instance, since cables are typically connected to poles (a kind of spatial relationship), poles may be migrated to the second network topology 314 before cables and other facilities objects 308 are migrated, thus taking advantage of known spatial relationships between poles and cables. However, any order for populating the second landbase map 312 with the facilities object 308 is within the scope of this embodiment.

In one embodiment, spatial relationships between at least two of the facilities object 308 are identified. In this embodiment, the facilities object 308 may be migrated to the second landbase map 312 according to the spatial relationship between the facilities objects 308. In other words, spatial relationships between two or more facilities objects, such as a cable and a pole, may be utilized rather than, or in addition to, the spatial relationships between the facilities object 308 and the landbase features.

In one embodiment, user selections for intervening in the automated population of the second landbase map 312 are provided. In this embodiment, the user may manually input data for assisting with the automated population of the second landbase map 312. For instance, the user may initially clarify the order of population of the facilities object 308 onto the second landbase map 312. Alternatively, the user may allow the automated population of the second landbase map 312 to occur and intervene when the program requests additional input from the user or intervention may occur at the user's discretion. The additional input may be, for example, another road intersection associated with the second landbase map 312 that corresponds with a road intersection on the first landbase map 306. The user may manually select the new intersection, enter data providing the coordinates of the new intersection, choose the intersection or any other additional input related data from a drop down menu, etc. Any manner of receiving additional input from the user is within the scope of the present embodiment. Further, and any type of additional input related data is within the scope of the present embodiment.

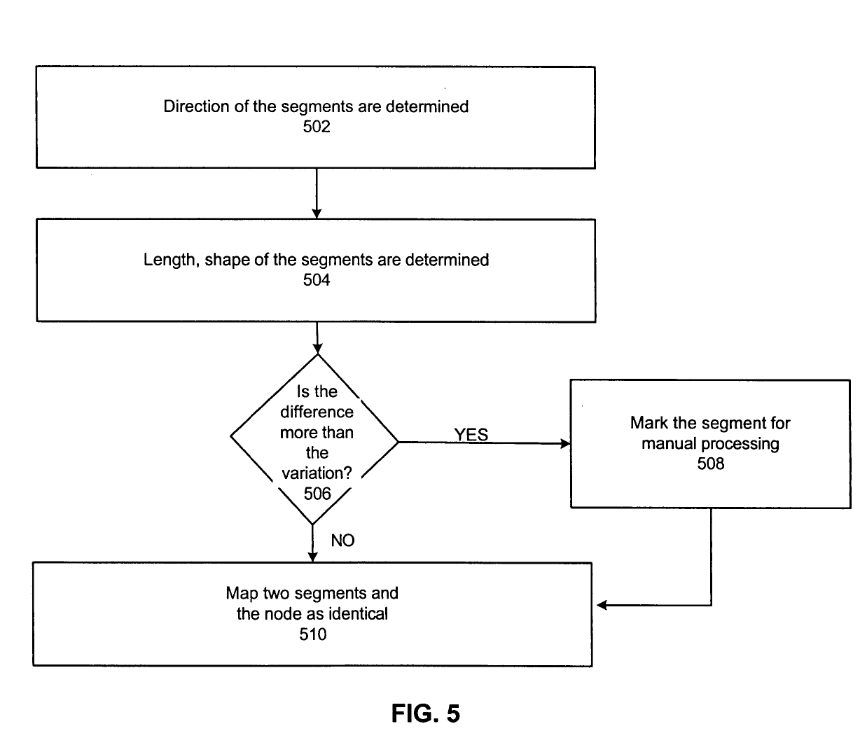

Turning now to FIG. 5, a flowchart showing the process for matching (e.g. evaluating similarities between) segments exiting from the identical nodes from the first network topology 304 and the second network topology 314 is shown. In step 502, the direction (angle of exiting from the node) of a segment from the first network topology 304 is compared with the direction of a segment exiting from the identical node from the second network topology 314. In step 504, geometry parameters of a segment from the first network topology 304 are compared with the corresponding geometry parameters of a segment from the second network topology 314. Geometry parameters may be, for example, the length of the segment, the shape of the segment, etc. In step 506, it is determined whether the difference between geometry parameters of the two segments is more than a variation factor. The variation factor may be a configurable parameter that defines the percentage (%) of possible variation in length and/or direction of segments or any other parameter. The variation factor is utilized to determine whether segments from the first network topology 304 and the second network topology 314 are identical segments. For instance, the variation factor may be 10%. However, any percentage variation is within the scope of this embodiment.

Segments 408 will be mapped to the identical segments 404 in the second network topology 314, in step 510, if the difference between evaluated geometry parameters is not more than the variation factor. If the difference between the evaluated geometry parameters is more than the variation factor these segments 408 will be marked for manual processing in step 508. Once the segments 408 are marked for manual processing and a user processes these segments 408, the segments 408 will be mapped to the identical segments 404 in the second network topology, in step 510. Alternatively, identical segments 404 may not be identified by the user. If identical segments 404 are not identified by the user, the user may manually locate facilities objects on the second network topology 314 with respect to those segments 408.

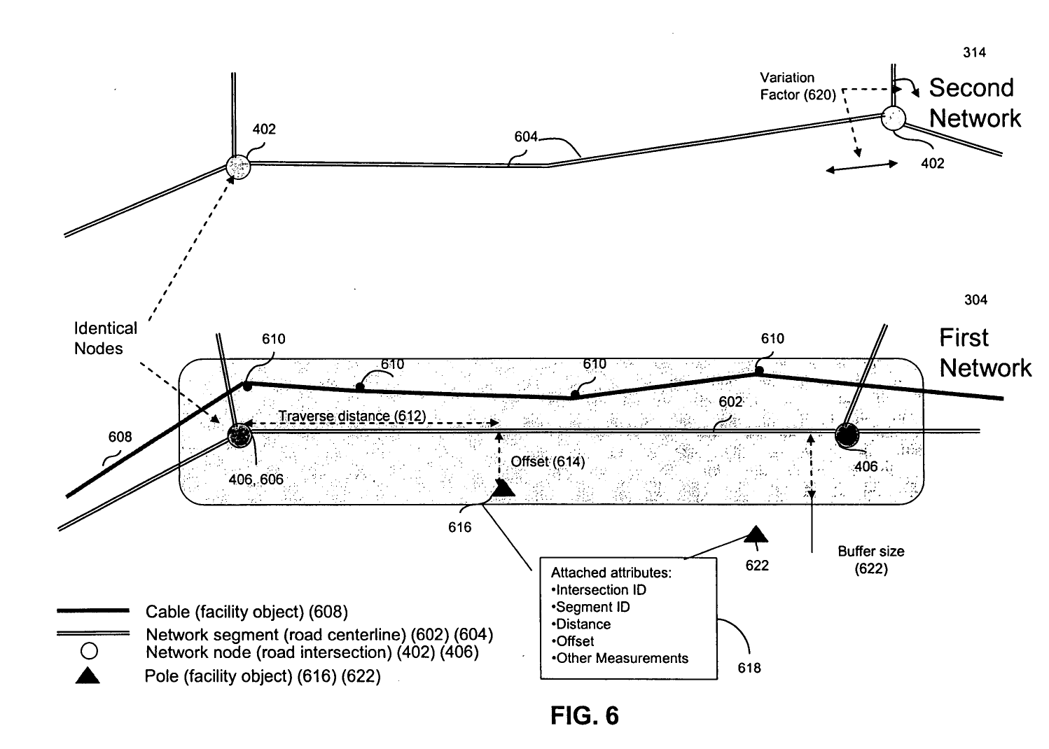

Turning now to FIG. 6, a schematic diagram of segments (road centerlines) 602 from the first network topology 304, and segments (road centerlines) 604 from the second network topology 314 are shown. Several modes (road intersections) are identified by circles. Nodes 406 are identified for the first network 304 and nodes 402 are identified for the second network 314. One of the nodes 406 is identified as a start node 606 in FIG. 6, indicating that a user may have selected this particular node (road intersection) 606 as a starting point for automatically populating the correspondence matrix.

A cable 608 is identified by a bold line in FIG. 6. The cable 608 may be migrated to maintain the location relationship with the segment 604. Migrating typically relocates the one or more facilities objects 308 on the second network topology 314 according to the same or similar spatial relationship the one or more facilities objects 308 had to landbase features on the first network topology 304. In other words, the spatial relationship the one or more facilities objects 308 had to landbase features on the first network topology 304 is preserved when these one or more facilities objects 308 are relocated on the second network topology 314. The cable 608 may indicate the placement of facilities objects 308 along the segment (road centerline) 602. The line graphically representing the cable 608 may include several vertices 610. The vertices 610 may be locations where two sections of the cable 608 meeting at a particular location.

In order to migrate facilities objects from the first network topology 304 to the second network topology 314, spatial relationships may be identified and/or recorded in a database. These spatial relationships between a facility object such as the pole 616, indicated by a triangle in FIG. 6, and the segment 602 may include the distance (traversal) from the node 406, to the projection of the point on the segment and the offset to the point, and/or any other type of measurements. The projection of a point along a segment is the point on the segment with the minimum distance to the specified point. The offset of a point along a segment is the perpendicular distance between the point and the segment. Offsets are positive if the points are on the left side along the segment direction and are negative if they are on the right side. Points are on a segment if their offsets to the segment are zero.

The spatial relationship data may be recorded in the form of tabular attributes 618 and attached to each vertex/point of a facility object, such as the one or more facilities objects 308 described herein. FIG. 6 also shows a variation factor 620 and a buffer 622. A buffer 622 around a segment 602 may be used in selecting vertexes or points of facilities objects that may be spatially associated with or related to a segment. A variation factor 620 may be used in matching corresponding segments 602, 604.

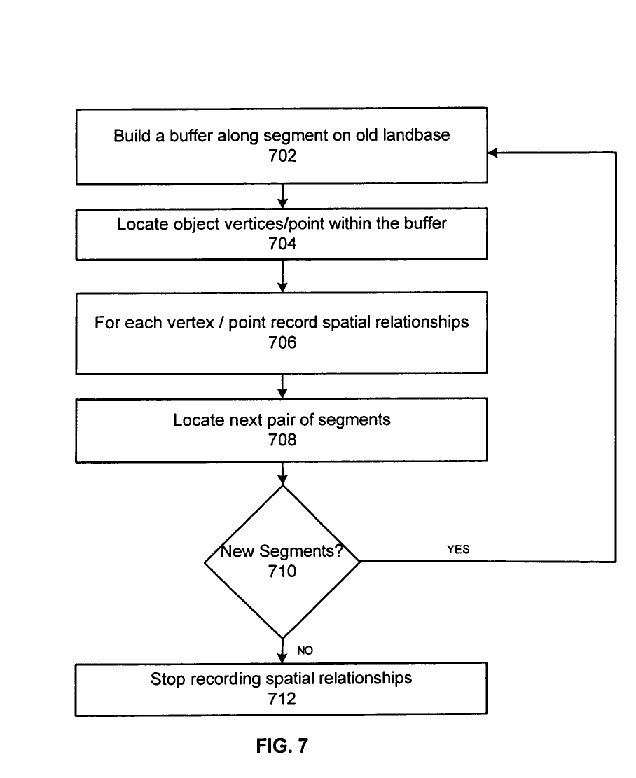

Turning now to FIG. 7, a flowchart for illustrating the workflow for recording relationships between landbase features 310, such as the old road centerline 602, and facilities objects 308, such as the pole 616 shown in FIG. 6, is shown. A buffer is built around a segment in the first network topology at step 702. Size of the buffer may be a configurable parameter that defines an area where any vertex of the facility object 308, or a point representing a facility object, may be considered to be related to a landbase feature 310. Vertices and points outside the particular buffer may be considered to have no explicit spatial relationship with the landbase feature. Points and/or vertices 610 within the buffer are selected at step 704. At step 706, a spatial relationship (for example, the distance from the node 612 and the offset from the segment 614) is calculated and attached as attributes to each selected point and/or vertex 610 within the buffer. If a next pair of corresponding segments in the first network topology 304 and the second network topology 314 can be located at step 710, the processor 302 returns to step 702 to build a buffer along the segment in the first network topology. If a next pair of segments cannot be located at step 710, the processor 302 stops identifying spatial relationships at step 712. At this stage all vertices/points of facilities objects that can be explicitly spatially related to the first network topology 304 are marked as processed.

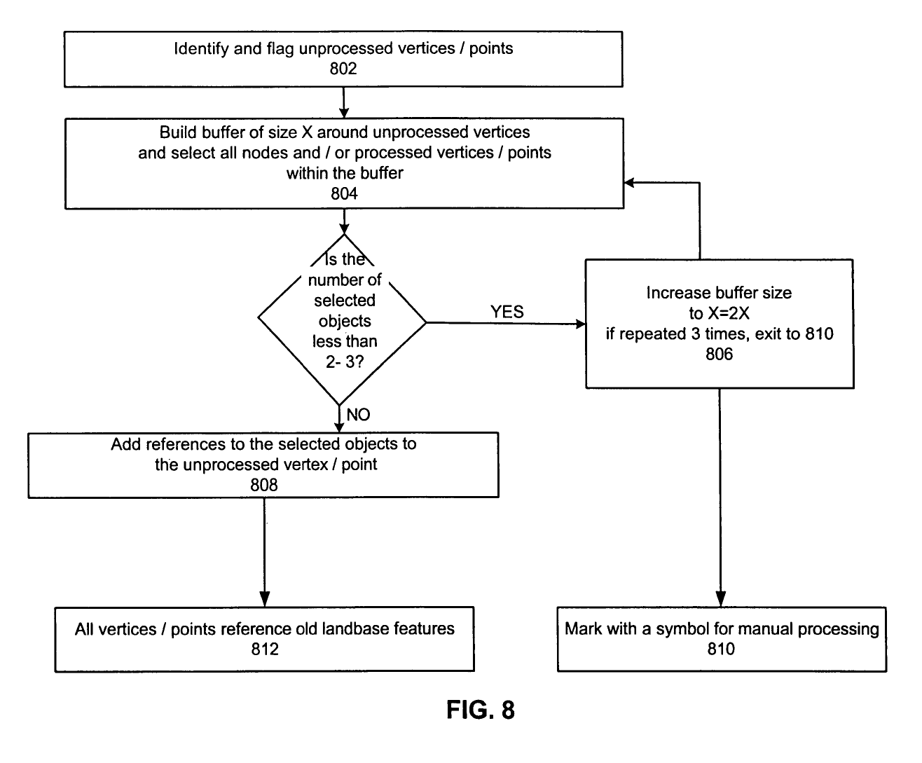

Turning now to FIG. 8, a flowchart illustrating a process for addressing unprocessed vertices and/or points of facilities is shown. A vertex/point may be treated as unprocessed (e.g. without explicitly recorded spatial relationships to the old landbase objects 306) if the vertex/point was not processed in the steps set forth in FIG. 7. At step 802, unprocessed vertices or points 622 are identified and flagged. For each unprocessed vertex or point 622, a buffer is built of size X (X is a configurable value) and all the nodes 406 and processed vertices 610 and points 616 are selected within the buffer at step 804. At step 806, if the total number of the selected nodes 406, vertices 610 and points 616 is less than 2-3, the buffer size 622 may increase (e.g. doubled). References to the selected one or more facilities objects 308 are added to the unprocessed vertex/point at step 808. If the intersection nodes 406 or processed vertices/points are not revealed after repeating step 806 at number of times, such as 3 times, intervention from a user may be required and such vertices or points are marked with a special symbol at step 810 to be migrated manually at step 908. However, repeating step 806 one or more times is within the scope of the embodiment. At step 812, all unprocessed in the steps set forth in FIG. 7 vertices or points related to the facilities data within the first network topology 304 reference the nodes 406 and/or processed vertices 610/points 616 related to the facilities data within the first network topology 304 or marked for manual processing.

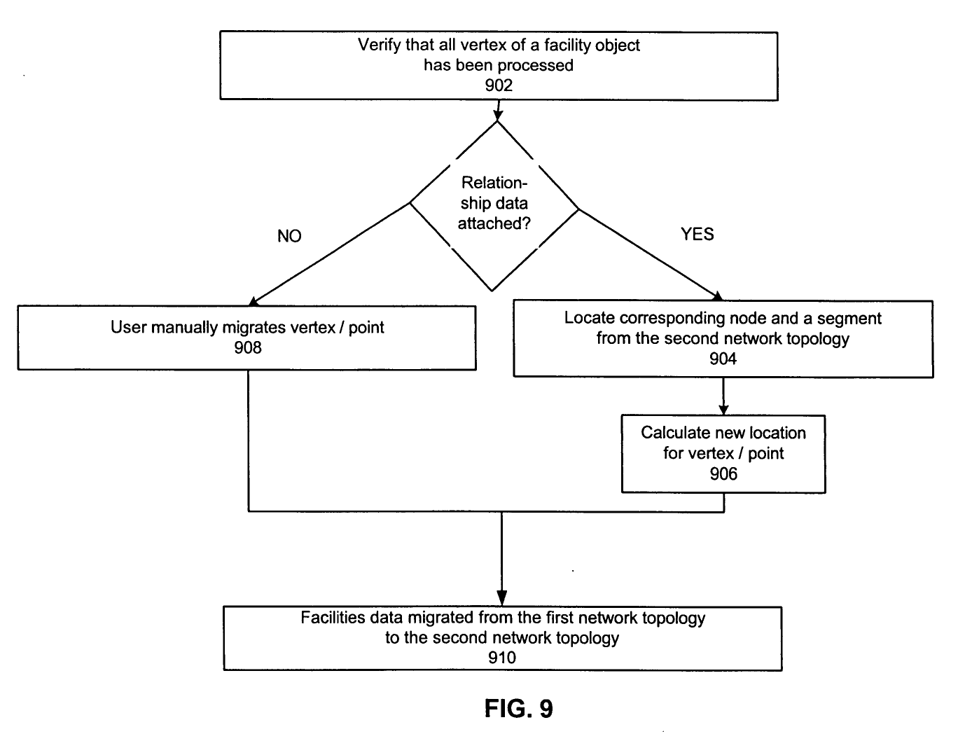

Turning now to FIG. 9, a flowchart for illustrating the migration of the one or more facilities objects 308 from a first landbase map 306 to a second landbase map 312 is shown. At step 902, it is verified that each vertex for a particular facilities object 308 has been processed. Processing may indicate that the relationship data 618, has been attached to the vertex 610 or point 616, 622.

At step 904, if the relationship data 618 is attached to a vertex or point, this relationship data and the correspondence matrix may be used to locate a node 402 and segment 404 from the second network topology 314 that were mapped to the node 406 and the segment 408 from the first network topology 304. At step 906, the relationship data 618 may be utilized to calculate a new location of the vertex/point against the node 402 and the segment 404 from the second network topology. For vertices or points 622 that reference other objects, a new location may be calculated with mathematical transformation using the location of the referenced objects as control points. By migrating all vertices of a facility object 308, the object is actually migrated to the second landbase map 312. At step 908, the user may manually move remaining unprocessed vertices or points 622 that have been marked with a special symbol at step 810. At step 910, all facilities data has been migrated from the first landbase map 306 to the second landbase map 312.

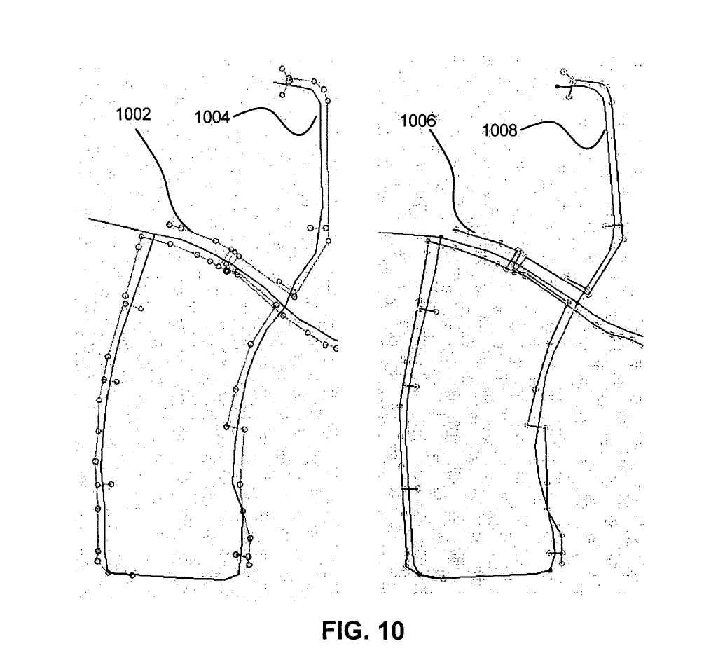

Turning now to FIG. 10, a diagram illustrating the resultant migration of facilities data from the first landbase map 306 to the second landbase map 312 is shown. The cables 1002 from the first landbase map 306, are shown on the left side. The migrated cables 1006 associated with the second landbase map 312 are shown on the right side. The migrated cables have exactly the same spatial relationship to the new road centerline 1008 as the cable 1002 had to the old road centerline 1004. Accordingly, the spatial relationships between the one or more facilities objects 308 have been maintained from the old landbase map 306 to the new landbase map 312.

While various embodiments have been described above, it should be understood that they have been presented by way of example only, and not limitation. It is not intended that the foregoing description to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for migrating spatial data between databases, comprising:
accessing a first network topology associated with a first landbase map and a second network topology associated with a second landbase map to automatically map identical nodes and segments therebetween;
identifying spatial relationships between at least one facilities object and landbase objects associated with the first network topology;
automatically populating the second landbase map with the facilities object according to the identified spatial relationships applied against the second network topology.

2. The method as recited in claim 1, further comprising selecting a node from the second network topology associated with the second landbase map that is identical to a node from the first network topology associated with the first landbase map in order to initiate the automatic populating of the second landbase map with the facilities object.

3. The method as recited in claim 1, wherein the facilities object populates the second landbase map according to a specific order.

4. The method as recited in claim 1, further comprising identifying spatial relationships between at least two of the facilities objects.

5. The method as recited in claim 4, wherein the facilities object is migrated according to the spatial relationships between at least two of the facilities objects.

6. The method as recited in claim 1, further comprising allowing a user to manually intervene in the automated population of the second landbase map.

7. The method as recited in claim 6, further comprising providing user selections for intervening in the automated population of the second landbase map.

8. An apparatus for migrating spatial data between databases, comprising:
a computer;
logic, performed by the computer, for:
accessing a first network topology associated with a first landbase map and a second network topology associated with a second landbase map to automatically map identical nodes and segments therebetween;
identifying spatial relationships between at least one facilities object and landbase objects associated with the first network topology;
automatically populating the second landbase map with the facilities object according to the identified spatial relationships applied against the second network topology.

9. The apparatus as recited in claim 8, further comprising logic for selecting a node from the second network topology associated with the second landbase map that is identical to a node from the first network topology associated with the first landbase map in order to initiate the automatic populating of the second landbase map with the facilities object.

10. The apparatus as recited in claim 8, wherein the facilities object populates the second landbase map according to a specific order.

11. The apparatus as recited in claim 8, further comprising logic for identifying spatial relationships between at least two of the facilities objects.

12. The apparatus as recited in claim 11, wherein the facilities object is migrated according to the spatial relationships between at least two of the facilities objects.

13. The apparatus as recited in claim 8, further comprising logic for allowing a user to manually intervene in the automated population of the second landbase map.

14. The apparatus as recited in claim 13, further comprising logic for providing user selections for intervening in the automated population of the second landbase map.

15. An article of manufacture embodying logic for performing a method for migrating spatial data between databases, comprising:
accessing a first network topology associated with a first landbase map and a second network topology associated with a second landbase map to automatically map identical nodes and segments therebetween;
identifying spatial relationships between at least one facilities object and landbase objects associated with the first network topology;
automatically populating the second landbase map with the facilities object according to the identified spatial relationships applied against the second network topology.

16. The article as recited in claim 15, further comprising selecting a node from the second network topology associated with the second landbase map that is identical to a node from the first network topology associated with the first landbase map in order to initiate the automatic populating of the second landbase map with the facilities object.

17. The article as recited in claim 15, wherein the facilities object populates the second landbase map according to a specific order.

18. The article as recited in claim 15, further comprising identifying spatial relationships between at least two of the facilities objects.

19. The article as recited in claim 18, wherein the facilities object is migrated according to the spatial relationships between at least two of the facilities objects.

20. The article as recited in claim 15, further comprising allowing a user to manually intervene in the automated population of the second landbase map.

21. The article as recited in claim 20, further comprising providing user selections for intervening in the automated population of the second landbase map.
